(19) United States
(12) Patent Application Publication
(10) Pub. No.: US 2015/0085532 A1
(43) Pub. Date: Mar. 26, 2015

(54) REACTOR AND POWER CONVERSION DEVICE

(71) Applicant: Toyota Jidosha Kabushiki Kaisha, Toyota-shi Aichi-ken (JP)

(72) Inventor: Fumiki Tanahashi, Toyota-shi Aichi-ken (JP)

(21) Appl. No.: 14/490,261

(22) Filed: Sep. 18, 2014

(30) Foreign Application Priority Data
Sep. 25, 2013 (JP) 2013-198966

(51) Int. Cl. H01F 27/28; H01F 27/24; H02M 3/335

(52) U.S. Cl. CPC H01F 27/28; H02M 3/33546; H01F 27/24
USPC 363/17; 336/221

(57) ABSTRACT

A reactor device includes: a magnetic core defining a predetermined axis; a first coil wound around the predetermined axis; and a second coil wound around the predetermined axis and placed opposed to the first coil, wherein: a first lead part and a second lead part formed in both ends of the first coil are placed on that side of the first coil which is opposed to the second coil.

### INCORPORATION BY REFERENCE

The disclosure of Japanese Patent Application No. 2013-198966 filed on Sep. 25, 2013 including the specification, drawings and abstract is incorporated herein by reference in its entirety.

### BACKGROUND OF THE INVENTION

1. Field of the Invention

The present invention relates to a reactor and a power conversion device.

2. Description of Related Art

There has been known a configuration of a reactor in which a coil is formed in a specific shape, a case serving as a heat dissipation path is provided, and an outer peripheral surface of the coil partially makes contact with the case so as to increase a heat dissipation property (see Japanese Patent Application Publication No. 2012-039099 (JP 2012-039099 A), for example).

Further, in a power conversion device including a primary side circuit, and a secondary side circuit magnetically coupled with the primary side circuit via a transformer, such a circuit has been known that two reactors magnetically coupled with each other are provided in the primary side circuit and the secondary side circuit (see Japanese Patent Application Publication No. 2011-193713 (JP 2011-193713 A), for example). In the meantime, the reactor described in JP 2012-039099 A is a single reactor, and two lead parts formed in both ends of the coil are placed not on the same side in an axial direction, but on opposite sides in the axial direction.

In a case where such a configuration is applied to each of the two reactors magnetically coupled with each other as described in JP 2011-193713 A and the two reactors are formed coaxially, an amount of heat generation is increased on facing-surface sides of the two reactors. That is, respective magnetic fluxes concentrate on the facing-surface sides of the two reactors, thereby resulting in that eddy current is easy to occur on respective facing surfaces of the coils, which may increase the amount of heat generation.

### SUMMARY OF THE INVENTION

The present invention provides a reactor and a power conversion device each of which is able to diffuse heat efficiently or to reduce heat generation while two coils are wound coaxially.

A reactor according to a first aspect of the present invention includes: a magnetic core that defines a predetermined axis; a first coil that is wound around the predetermined axis; and a second coil that is wound around the predetermined axis and is placed opposed to the first coil, wherein a first lead part and a second lead part formed in both ends of the first coil are placed on that side of the first coil which is opposed to the second coil.

A reactor according to a second aspect of the present invention includes: a magnetic core that defines a predetermined axis; a first coil that is wound around the predetermined axis; and a second coil that is wound around the predetermined axis alternately with the first coil in a direction of the predetermined axis.

A power conversion device according to a third aspect of the present invention includes: a primary side circuit provided with a first reactor including a first magnetic core that defines a first predetermined axis, a first coil that is wound around the first predetermined axis, and a second coil that is wound around the first predetermined axis and is placed opposed to the first coil, the first coil includes a first lead part and a second lead part formed in both ends of the first coil, the first lead part and the second lead part are placed on that side of the first coil which is opposed to the second coil; and a secondary side circuit that is magnetically coupled with the primary side circuit via a transformer and is provided with a second reactor that includes a second magnetic core defining a second predetermined axis, a third coil that is wound around the second predetermined axis, and a fourth coil that is wound around the second predetermined axis and is placed opposed to the third coil, the third coil includes a third lead part and a fourth lead part that are formed in both ends of the third coil, the third lead part and the fourth lead part are placed on that side of the third coil which is opposed to the fourth coil.

A power conversion device according to a fourth aspect of the present invention includes: a primary side circuit provided with a first reactor device including a first magnetic core defining a first predetermined axis, a first coil wound around the first predetermined axis, and a second coil wound around the first predetermined axis alternately with the first coil in a direction of the first predetermined axis; and a secondary side circuit that is magnetically coupled with the primary side circuit via a transformer and is provided with a second reactor that includes a second magnetic core that defines a second predetermined axis, a third coil that is wound around the second predetermined axis, and a fourth coil that is wound around the second predetermined axis alternately with the third coil in a direction of the second predetermined axis.

According to the above aspects, it is possible to obtain a reactor device and a power conversion device each of which is able to diffuse heat efficiently or to reduce heat generation while two coils are wound coaxially.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram illustrating a configuration of a power conversion device according to one embodiment of the present invention;

FIG. 2 is a perspective view illustrating a reactor device according to one embodiment (Embodiment 1);

FIG. 3 is a view schematically illustrating a first coil and a second coil in the reactor device;

FIG. 4A is a view diagrammatically illustrating a state where the first coil and the second coil are wound around a magnetic core as an example of winding of the first coil and the second coil;

FIG. 4B is a view diagrammatically illustrating a state where the first coil and the second coil are wound around the magnetic core as the example of the winding of the first coil and the second coil;

FIGS. 5A to C are views illustrating other examples of the winding of the first coil and the second coil;

FIGS. 6A, 6B are views each schematically illustrating a first coil and a second coil in a comparative example;

FIG. 7 is an explanatory view of a reason why heat generation increases in a facing portion between the first coil and the second coil;

FIG. 8 is a top view diagrammatically illustrating a reactor device according to Embodiment 2 of the present invention;

FIG. 9 is a sectional view illustrating a reactor device according to Embodiment 3 of the present invention;

FIG. 10 is a view schematically illustrating a first coil and a second coil in the reactor device;

FIG. 11 is a view schematically illustrating a state of magnetic fluxes caused in the reactor device; and

FIG. 12 is a sectional view diagrammatically illustrating a reactor device according to Embodiment 4 of the present invention.

### DETAILED DESCRIPTION OF EMBODIMENTS

The following describes each embodiment in detail with reference to the attached drawings.

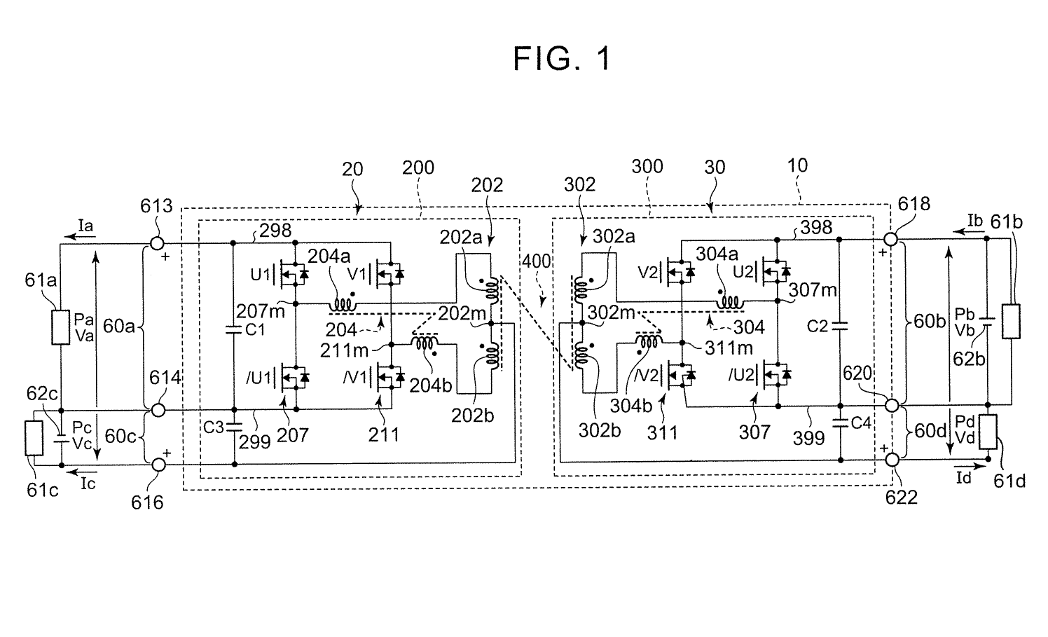

FIG. 1 is a block diagram illustrating a configuration of a power conversion device 10 according to one embodiment. The power conversion device 10 may be used, for example, in a system which is provided in a vehicle such as an automobile and which supplies electricity to each load in the vehicle.

The power conversion device 10 includes, as a primary side port, a first input-output port 60a to which a primary-side high-voltage load 61a is connected, and a second input-output port 60c to which a primary-side low-voltage load 61c and a primary-side low-voltage power supply 62c are connected, for example. The primary-side low-voltage power supply 62c supplies electric power to the primary-side low-voltage load 61c that works at the same voltage system (for example, 12-V system) as the primary-side low-voltage power supply 62c. Further, the primary-side low-voltage power supply 62c supplies electric power boosted by a primary-side conversion circuit 20 provided in the power conversion device 10, to the primary-side high-voltage load 61a that works at a voltage system (for example, 48-V system higher than the 12-V system) different from that of the primary-side low-voltage power supply 62c. A concrete example of the primary-side low-voltage power supply 62c includes a secondary battery such as a lead battery. The power conversion device 10 includes, as a secondary side port, a third input-output port 60b to which a secondary-side high-voltage load 61b and a secondary-side high-voltage power supply 62b are connected, and a fourth input-output port 60d to which a secondary-side low-voltage load 61d is connected, for example.

The power conversion device 10 is a power converter circuit which includes four input-output ports described above and which has a function to perform power conversion between two input-output ports selected from among the four input-output ports.

Port electric powers Pa, Pc, Pb, Pd are respective input/output electric powers (input electric power or output electric power) of the first input-output port 60a, the second input-output port 60c, a third input-output port 60b, and a fourth input-output port 60d. Port voltages Va, Vc, Vb, Vd are respective input/output voltages (input voltage or output voltage) of the first input-output port 60a, the second input-output port 60c, the third input-output port 60b, and the fourth input-output port 60d. Port currents Ia, Ic, Ib, Id are respective input/output currents (input current or output current) of the first input-output port 60a, the second input-output port 60c, the third input-output port 60b, and the fourth input-output port 60d.

The power conversion device 10 includes a capacitor C1 provided in the first input-output port 60a, a capacitor C3 provided in the second input-output port 60c, a capacitor C2 provided in the third input-output port 60b, and a capacitor C4 provided in the fourth input-output port 60d. Concrete examples of the capacitors C1, C2, C3, C4 include a film capacitor, an aluminum electrolytic capacitor, a ceramic capacitor, a solid polymer capacitor, and the like.

The capacitor C1 is inserted between a high-voltage-side terminal 613 of the first input-output port 60a and a low-voltage-side terminal 614 of the first input-output port 60a and the second input-output port 60c. The capacitor C3 is inserted between a high-voltage-side terminal 616 of the second input-output port 60c and the low-voltage-side terminal 614 of the first input-output port 60a and the second input-output port 60c. The capacitor C2 is inserted between a high-voltage-side terminal 618 of the third input-output port 60b and a low-voltage-side terminal 620 of the third input-output port 60b and the fourth input-output port 60d. The capacitor C4 is inserted between a high-voltage-side terminal 622 of the fourth input-output port 60d and the low-voltage-side terminal 620 of the third input-output port 60b and the fourth input-output port 60d.

The power conversion device 10 is a power converter circuit constituted by the primary-side conversion circuit 20 and a secondary-side conversion circuit 30. Note that the primary-side conversion circuit 20 and the secondary-side conversion circuit 30 are connected to each other via a primary-side magnetic coupling reactor 204 and a secondary-side magnetic coupling reactor 304, and are magnetically coupled with each other via a transformer 400 (a center-tap transformer).

The primary-side conversion circuit 20 is a primary side circuit including a primary-side full bridge circuit 200, the first input-output port 60a, and the second input-output port 60c. The primary-side full bridge circuit 200 is a primary-side power converting portion constituted by a primary side coil 202 of the transformer 400, the primary-side magnetic coupling reactor 204, a primary-side first upper arm U1, a primary-side first lower arm /U1, a primary-side second upper arm V1, and a primary-side second lower arm /V1. Here, the primary-side first upper arm U1, the primary-side first lower arm /U1, the primary-side second upper arm V1, and the primary-side second lower arm /V1 are each a switching element including an N-channel MOSFET, and a body diode, which is a parasitic element of the MOSFET, for example. A diode may be additionally connected in parallel to the MOSFET.

The primary-side full bridge circuit 200 includes a primary-side positive electrode bus 298 connected to the high-voltage-side terminal 613 of the first input-output port 60a, and a primary-side negative electrode bus 299 connected to the low-voltage-side terminal 614 of the first input-output port 60a and the second input-output port 60c.

A primary-side first arm circuit 207 that connects the primary-side first upper arm U1 to the primary-side first lower arm /U1 in series is attached between the primary-side positive electrode bus 298 and the primary-side negative electrode bus 299. The primary-side first arm circuit 207 is a primary-side first power converter circuit portion (a primary-side U-phase power converter circuit portion) that can perform a power conversion operation according to ON/OFF switching operations of the primary-side first upper arm U1 and the primary-side first lower arm /U1. Further, a primary-side second arm circuit 211 that connects the primary-side second upper arm V1 to the primary-side second lower arm /V1 in series is attached between the primary-side positive electrode bus 298 and the primary-side negative electrode bus 299 in parallel to the primary-side first arm circuit 207. The primary-side second arm circuit 211 is a primary-side second power converter circuit portion (a primary-side V-phase power converter circuit portion) that can perform a power conversion operation according to ON/OFF switching operations of the primary-side second upper arm V1 and the primary-side second lower arm /V1.

A bridge portion that connects a middle point 207m of the primary-side first arm circuit 207 to a middle point 211m of the primary-side second arm circuit 211 is provided with the primary side coil 202 and the primary-side magnetic coupling reactor 204. A connection relationship in the bridge portion is described below more specifically. One end of a primary-side first reactor 204a of the primary-side magnetic coupling reactor 204 is connected to the middle point 207m of the primary-side first arm circuit 207. Then, one end of the primary side coil 202 is connected to the other end of the primary-side first reactor 204a. Further, one end of a primary-side second reactor 204b of the primary-side magnetic coupling reactor 204 is connected to the other end of the primary side coil 202. Furthermore, the other end of the primary-side second reactor 204b is connected to the middle point 211m of the primary-side second arm circuit 211. Note that the primary-side magnetic coupling reactor 204 is constituted by the primary-side first reactor 204a, and the primary-side second reactor 204b magnetically coupled with the primary-side first reactor 204a with a coupling coefficient k₁.

The middle point 207m is a primary-side first middle node between the primary-side first upper arm U1 and the primary-side first lower arm /U1, and the middle point 211m is a primary-side second middle node between the primary-side second upper arm V1 and the primary-side second lower arm /V1.

The first input-output port 60a is a port provided between the primary-side positive electrode bus 298 and the primary-side negative electrode bus 299. The first input-output port 60a is constituted by the terminal 613 and the terminal 614. The second input-output port 60c is a port provided between the primary-side negative electrode bus 299 and a center tap 202m of the primary side coil 202. The second input-output port 60c is constituted by the terminal 614 and the terminal 616.

The center tap 202m is connected to the high-voltage-side terminal 616 of the second input-output port 60c. The center tap 202m is a middle connecting point between a primary-side first winding 202a and a primary-side second winding 202b provided in the primary side coil 202.

The secondary-side conversion circuit 30 is a secondary side circuit constituted by a secondary-side full bridge circuit 300, the third input-output port 60b, and the fourth input-output port 60d. The secondary-side full bridge circuit 300 is a secondary-side power converting portion including a secondary side coil 302 of the transformer 400, the secondary-side magnetic coupling reactor 304, a secondary-side first upper arm U2, a secondary-side first lower arm /U2, a secondary-side second upper arm V2, and a secondary-side second lower arm /V2. Here, the secondary-side first upper arm U2, the secondary-side first lower arm /U2, the secondary-side second upper arm V2, and the secondary-side second lower arm /V2 are each a switching element including an N-channel MOSFET, and a body diode, which is a parasitic element of the MOSFET, for example.

The secondary-side full bridge circuit 300 includes a secondary-side positive electrode bus 398 connected to the high-voltage-side terminal 618 of the third input-output port 60b, and a secondary-side negative electrode bus 399 connected to the low-voltage-side terminal 620 of the third input-output port 60b and the fourth input-output port 60d.

A secondary-side first arm circuit 307 that connects the secondary-side first upper arm U2 to the secondary-side first lower arm /U2 in series is attached between the secondary-side positive electrode bus 398 and the secondary-side negative electrode bus 399. The secondary-side first arm circuit 307 is a secondary-side first power converter circuit portion (a secondary-side U-phase power converter circuit portion) that can perform a power conversion operation according to ON/OFF switching operations of the secondary-side first upper arm U2 and the secondary-side first lower arm /U2. Further, a secondary-side second arm circuit 311 that connects the secondary-side second upper arm V2 to the secondary-side second lower arm /V2 in series is attached between the secondary-side positive electrode bus 398 and the secondary-side negative electrode bus 399 in parallel to the secondary-side first arm circuit 307. The secondary-side second arm circuit 311 is a secondary-side second power converter circuit portion (a secondary-side V-phase power converter circuit portion) that can perform a power conversion operation according to ON/OFF switching operations of the secondary-side second upper arm V2 and the secondary-side second lower arm /V2.

A bridge portion that connects a middle point 307m of the secondary-side first arm circuit 307 to a middle point 311m of the secondary-side second arm circuit 311 is provided with the secondary side coil 302 and the secondary-side magnetic coupling reactor 304. A connection relationship in the bridge portion is described below more specifically. One end of a secondary-side first reactor 304a of the secondary-side magnetic coupling reactor 304 is connected to the middle point 307m of the secondary-side first arm circuit 307. Then, one end of the secondary side coil 302 is connected to the other end of the secondary-side first reactor 304a. Further, one end of a secondary-side second reactor 304b of the secondary-side magnetic coupling reactor 304 is connected to the other end of the secondary side coil 302. Furthermore, the other end of the secondary-side second reactor 304b is connected to the middle point 311m of the secondary-side second arm circuit 311. Note that the secondary-side magnetic coupling reactor 304 is constituted by the secondary-side first reactor 304a, and the secondary-side second reactor 304b magnetically coupled with the secondary-side first reactor 304a with a coupling coefficient k₂.

The middle point 307m is a secondary-side first middle node between the secondary-side first upper arm U2 and the secondary-side first lower arm /U2, and the middle point 311m is a secondary-side second middle node between the secondary-side second upper arm V2 and the secondary-side second lower arm /V2.

The third input-output port 60b is a port provided between the secondary-side positive electrode bus 398 and the secondary-side negative electrode bus 399. The third input-output port 60b is constituted by the terminal 618 and the terminal 620. The fourth input-output port 60d is a port provided between the secondary-side negative electrode bus 399 and a center tap 302m of the secondary side coil 302. The fourth input-output port 60d is constituted by the terminal 620 and the terminal 622.

The center tap 302m is connected to the high-voltage-side terminal 622 of the fourth input-output port 60d. The center tap 302m is a middle connecting point between a secondary-side first winding 302a and a secondary-side second winding 302b provided in the secondary side coil 302.

Here, the following describes a buck-boost function of the primary-side conversion circuit 20. In regard to the second input-output port 60c and the first input-output port 60a, the terminal 616 of the second input-output port 60c is connected to the middle point 207m of the primary-side first arm circuit 207 via the primary-side first winding 202a and the primary-side first reactor 204a connected in series to the primary-side first winding 202a. Since both ends of the primary-side first arm circuit 207 are connected to the first input-output port 60a, a buck-boost circuit is attached between the terminal 616 of the second input-output port 60c and the first input-output port 60a.

Further, the terminal 616 of the second input-output port 60c is connected to the middle point 211m of the primary-side second arm circuit 211 via the primary-side second winding 202b and the primary-side second reactor 204b connected in series to the primary-side second winding 202b. Moreover, since both ends of the primary-side second arm circuit 211 are connected to the first input-output port 60a, a buck-boost circuit is attached in parallel between the terminal 616 of the second input-output port 60c and the first input-output port 60a. Note that the secondary-side conversion circuit 30 is a circuit having generally the same configuration as the primary-side conversion circuit 20, and therefore, two buck-boost circuits are connected in parallel to each other between the terminal 622 of the fourth input-output port 60d and the third input-output port 60b. Accordingly, the secondary-side conversion circuit 30 has a buck-boost function similarly to the primary-side conversion circuit 20.

Next will be described a reactor device. The reactor device described below can be preferably used in the power conversion device 10. For example, the reactor device may be used as the primary-side magnetic coupling reactor 204, or may be used as the secondary-side magnetic coupling reactor 304. The following description deals with a case where the reactor device constitutes the primary-side magnetic coupling reactor 204, for example.

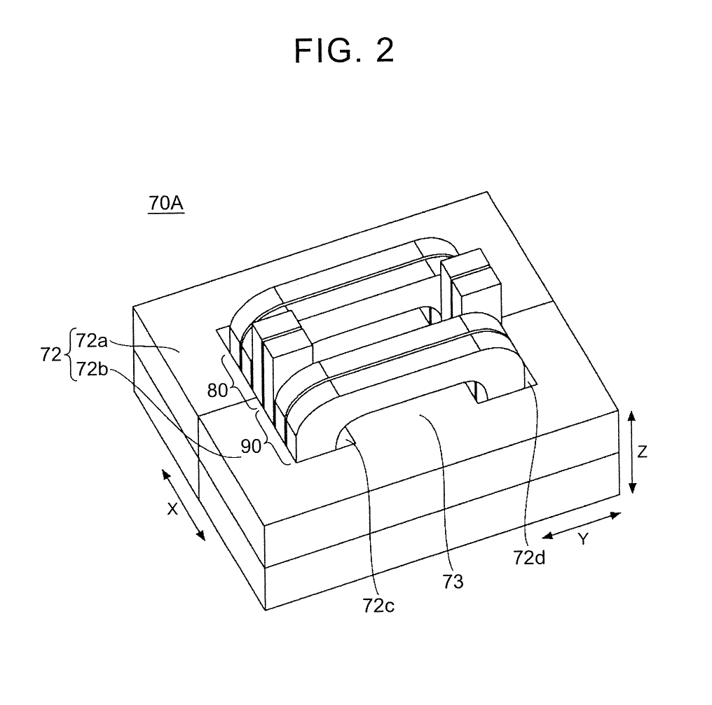

FIG. 2 is a perspective view illustrating a reactor device 70A according to one embodiment (Embodiment 1).

The reactor device 70A includes a magnetic core 72, a first coil 80, and a second coil 90.

The magnetic core 72 may be made of any magnetic material (e.g., a material including iron oxide, such as ferrite). In the example illustrated in FIG. 2, the magnetic core 72 includes two magnetic core elements 72a, 72b. The magnetic core elements 72a, 72b are E-type cores, and are placed opposed to each other in a state where two slots 72c, 72d are defined. In such a configuration, the same components can be used as the magnetic core elements 72a, 72b. Note that the magnetic core 72 may be formed in combination of an E-type core and an I-type core (that is, an EI-type core). Further, the magnetic core 72 may be a punched core or may be a laminated core.

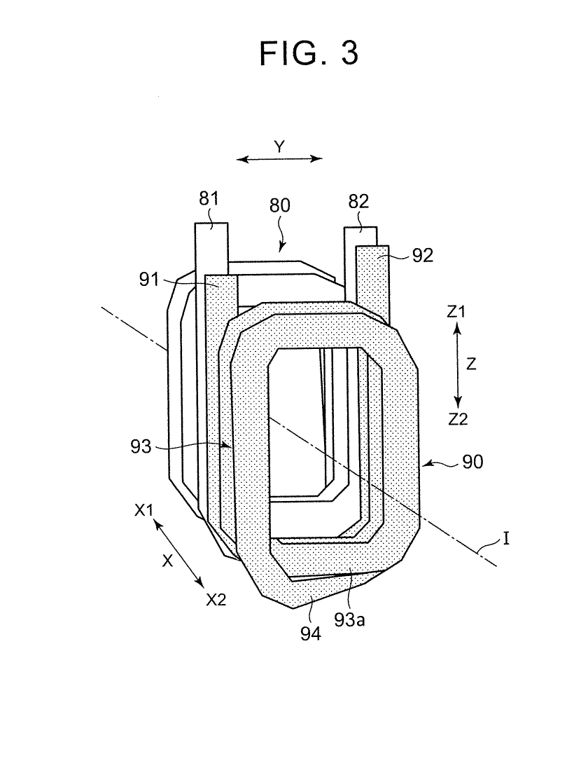

A first coil 80 and a second coil 90 are placed coaxially around a predetermined axis. In the example illustrated in FIG. 2, the first coil 80 and the second coil 90 are wound around a central leg 73 of the magnetic core 72 so as to pass through two slots 72c, 72d. In this case, the central leg 73 defines a predetermined axis I (see FIG. 3). The first coil 80 and the second coil 90 are typically made of the same material. Each of the first coil 80 and the second coil 90 is preferably formed of that square wire having a rectangular section which can handle a larger current as compared with a thin circular wire having a circular section, as illustrated in FIG. 2. However, each of the first coil 80 and the second coil 90 may be formed of a thin circular wire having a circular section.

FIG. 3 is a view schematically illustrating the first coil 80 and the second coil 90 in the reactor device 70A. FIG. 3 is a perspective view schematically illustrating only the first coil 80 and the second coil 90 taken out of the reactor device 70A illustrated in FIG. 2.

Since the first coil 80 and the second coil 90 are placed coaxially around the predetermined axis I as described above, they are opposed to each other in a direction (X-direction) of the predetermined axis I. In the following description, for descriptive purposes, those respective sides of the first coil 80 and the second coil 90 on which the first coil 80 and the second coil 90 are opposed to each other in the direction of the predetermined axis I are each referred to as a “facing side,” and opposite sides to the facing sides in the first coil 80 and the second coil 90 are each referred to as a “non-facing side.” For example, in FIG. 3, an X2 side of the first coil 80 in the direction of the predetermined axis I is a “facing side,” and an X1 side thereof is a “non-facing side.”

The first coil 80 includes a first lead part 81 and a second lead part 82. Lengths of the first lead part 81 and the second lead part 82 are optional. The first lead part 81 and the second lead part 82 serve as terminals, and are connected to other components (elements of an electric circuit). For example, in a case where the first coil 80 constitutes the primary-side first reactor 204a, the first lead part 81 and the second lead part 82 may be connected to the middle point 207m of the primary-side first arm circuit 207 and one end of the primary-side first winding 202a, respectively.

The first lead part 81 and the second lead part 82 of the first coil 80 are placed on the facing side of the first coil 80. That is, the first lead part 81 and the second lead part 82 are both placed on the facing side. Note that as far as the first lead part 81 and the second lead part 82 are placed on the facing side, they may be drawn in any direction on the facing side. For example, in the example of FIG. 3, the first lead part 81 and the second lead part 82 are drawn toward a Z1 side in a Z-direction. However, the first lead part 81 may be drawn toward the Z1 side in the Z-direction, and the second lead part 82 may be drawn toward a Z2 side in the Z-direction, for example.

The second coil 90 includes a third lead part 91 and a fourth lead part 92. Lengths of the third lead part 91 and the fourth lead part 92 are optional. The third lead part 91 and the fourth lead part 92 serve as terminals, and are connected to other components (elements of an electric circuit). For example, in a case where the second coil 90 constitutes the primary-side second reactor 204b, the third lead part 91 and the fourth lead part 92 may be connected to the middle point 211m of the primary-side second arm circuit 211 and one end of the primary-side second winding 202b, respectively.

The third lead part 91 and the fourth lead part 92 of the second coil 90 are placed on the facing side of the second coil 90. That is, the third lead part 91 and the fourth lead part 92 are both placed on the facing side. Note that as far as the third lead part 91 and the fourth lead part 92 are placed on the facing side, they may be drawn in any direction on the facing side. For example, in the example of FIG. 3, the third lead part 91 and the fourth lead part 92 are drawn toward the Z1 side in the Z-direction. However, the third lead part 91 may be drawn toward the Z1 side in the Z-direction, and the fourth lead part 92 may be drawn toward the Z2 side in the Z-direction, for example.

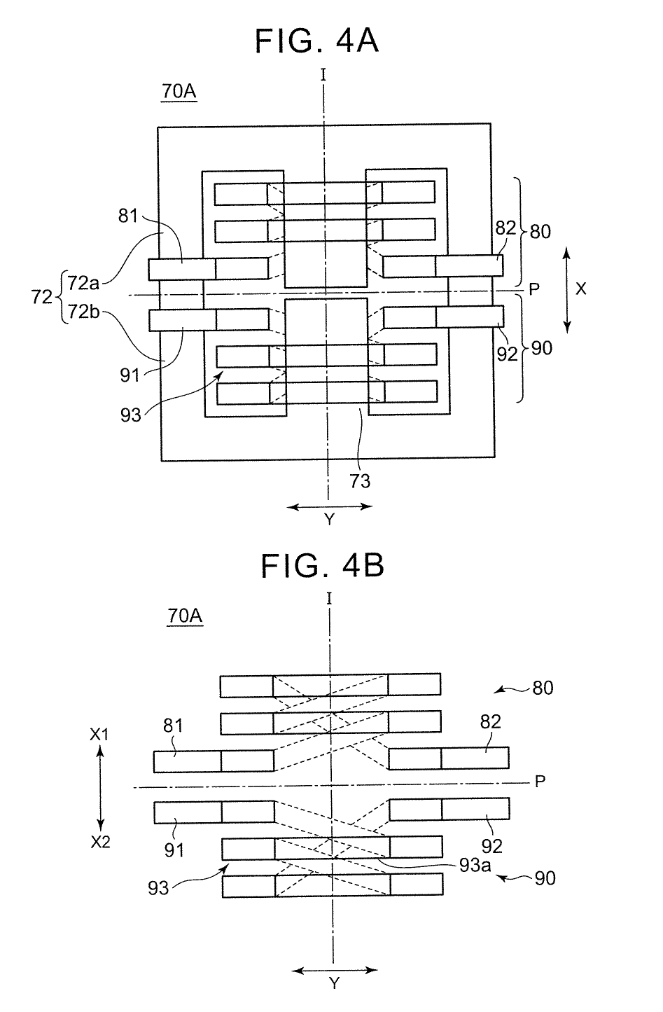

FIGS. 4A, 4B are views illustrating one example of winding of the first coil 80 and the second coil 90. FIG. 4A diagrammatically illustrates a state where the first coil 80 and the second coil 90 are wound around the magnetic core 72. FIG. 4B diagrammatically illustrates the first coil 80 and the second coil 90 taken out of the reactor device 70A. FIGS. 4A, 4B illustrate the first coil 80 and the second coil 90 in a top view (a view along the Z-direction of FIG. 3). In FIGS. 4A, 4B, P indicates a facing-side plane between the first coil 80 and the second coil 90. Herein, only winding of the second coil 90 (and its related configuration) is described as a typical example, but the first coil 80 may be wound in the same manner. Note that, in FIGS. 4A, 4B, dotted-line parts of the first coil 80 and the second coil 90 indicate parts wound on their back sides.

As illustrated in FIGS. 4A, 4B (also see FIG. 3), the second coil 90 includes a winding part 93 in addition to the third lead part 91 and the fourth lead part 92.

The winding part 93 is a part wound around the predetermined axis I, and serves as a body portion that substantially implements a magnetic flux forming function of the first coil 80. The third lead part 91 and the fourth lead part 92 are formed in both ends of the winding part 93. Note that the number of windings of the winding part 93 is optional.

The winding part 93 includes a single-layer winding part 93a wound in a single layer, and an intersecting part 94. The intersecting part 94 passes on an inner side or an outer side (the inner side is a side closer to the predetermined axis I in a radial direction around the predetermined axis I) of the single-layer winding part 93a, and intersects with the single-layer winding part 93a. In the example illustrated in FIGS. 4A, 4B (and FIG. 3), the intersecting part 94 passes on the outer side of the single-layer winding part 93a. Note that the intersecting part 94 may be formed outside the slots 72c, 72d of the magnetic core 72 in consideration of limited spaces of the slots 72c, 72d of the magnetic core 72.

The intersecting part 94 is formed so that the third lead part 91 and the fourth lead part 92 are both placed on the facing side as described above. In the example illustrated in FIGS. 4A, 4B, the second coil 90 is configured such that the single-layer winding part 93a (a part other than the intersecting part 94) of the winding part 93 is formed by three turns from the third lead part 91, and the intersecting part 94 is formed so as to return toward the facing side from the non-facing side. At this time, the intersecting part 94 is provided so as to extend toward the facing side across the outer side of the single-layer winding part 93a. Hereby, the fourth lead part 92 can be formed on the facing side.

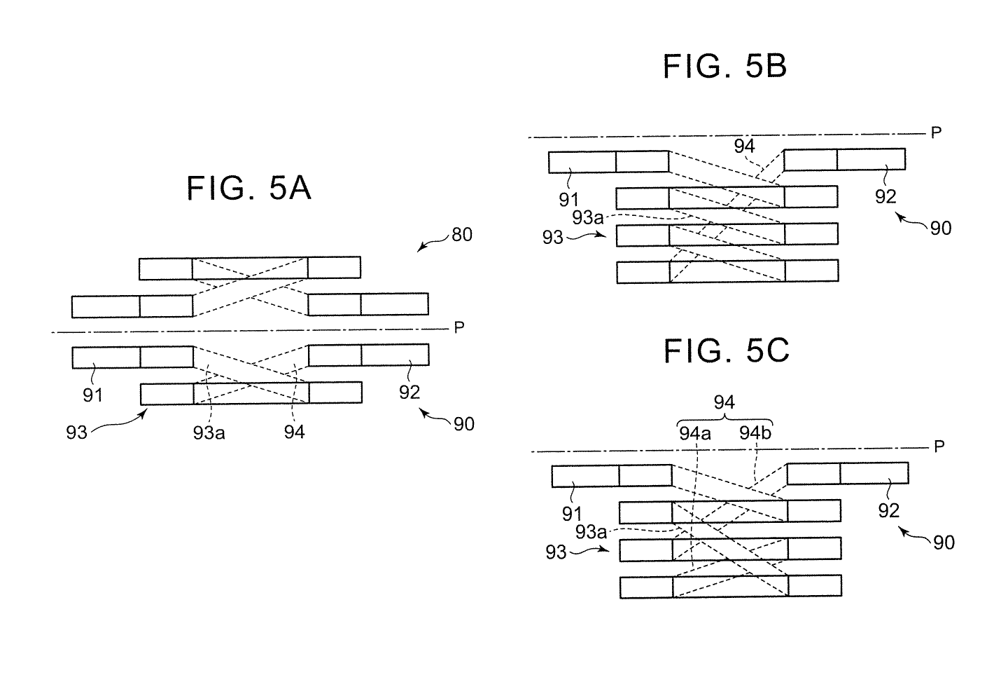

FIGS. 5A to 5C are views illustrating other examples of the winding of the first coil 80 and the second coil 90. In the following description, only the winding of the second coil 90 (and its related configuration) is described as a typical example, but the first coil 80 may be wound in the same manner.

In the example illustrated in FIG. 5A, the second coil 90 is wound in two turns. Similarly to the above, the intersecting part 94 passes on the outer side of the single-layer winding part 93a and extends toward the facing side. Hereby, the fourth lead part 92 can be formed on the facing side.

In the example illustrated in FIG. 5B, the second coil 90 is wound in four turns. Similarly to the above, the intersecting part 94 passes on the outer side of the single-layer winding part 93a and extends toward the facing side. Hereby, the fourth lead part 92 can be formed on the facing side. Thus, the number of windings of the second coil 90 is optional.

In the example illustrated in FIG. 5C, the second coil 90 is wound in four turns. In the example illustrated in FIG. 5C, the intersecting part 94 includes a first intersecting part 94a and a second intersecting part 94b. The first intersecting part 94a extends toward the facing side from the non-facing side only by one turn, and the second intersecting part 94b extends toward the non-facing side only by three turns. Hereby, the fourth lead part 92 can be formed on the facing side. Thus, the intersecting part 94 may be constituted by a plurality of intersecting parts.

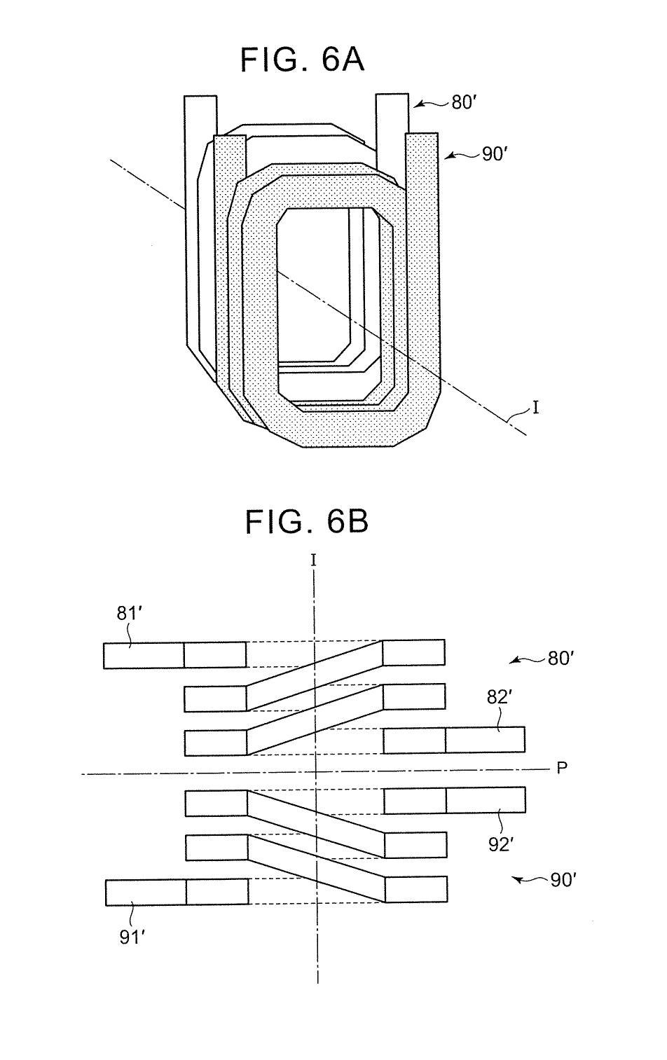

FIGS. 6A, 6B are views each schematically illustrating a first coil 80′ and a second coil 90′ in a comparative example. FIG. 6A is a view illustrated in comparison with FIG. 3. FIG. 6B is a view illustrated in comparison with FIG. 4B. In the comparative example, the first coil 80′ includes a first lead part 81′ on a non-facing side thereof, and includes a second lead part 82′ on a facing side thereof. Further, the second coil 90′ includes a third lead part 91′ on a non-facing side thereof, and includes a fourth lead part 92′ on a facing side thereof.

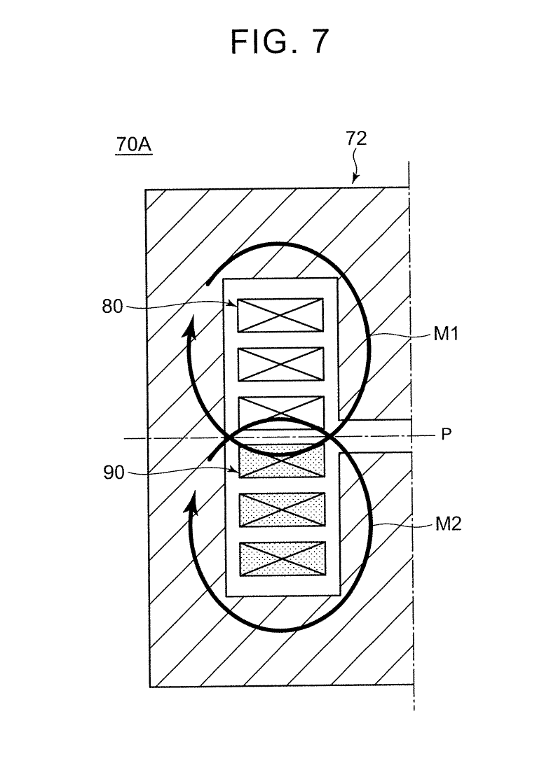

FIG. 7 is an explanatory view of a reason why heat generation increases in a facing portion between the first coil 80 and the second coil 90, and is a sectional view diagrammatically illustrating a left half of the reactor device 70A (a left half with respect to the predetermined axis I in the Y-direction) when the reactor device 70A is cut on a surface perpendicular to the Z-direction of FIG. 2.

In the present embodiment, since the first coil 80 and the second coil 90 are placed coaxially around the predetermined axis I as described above end surfaces of the first coil 80 and the second coil 90 on their facing sides are opposed to each other. When a current is applied to the first coil 80 and the second coil 90, respective magnetic fluxes M1, M2 are formed as diagrammatically illustrated in FIG. 7. The magnetic fluxes M1, M2 concentrate on between the end surfaces of the first coil 80 and the second coil 90 on their facing sides. Because of this, eddy current is easy to occur in the end surfaces of the first coil 80 and the second coil 90 on their facing sides, which causes such a problem that an amount of heat generation increases.

In this regard, in a case of the comparative example illustrated in FIGS. 6A,6B, the first coil 80′ and the second coil 90′ just include two lead parts (the second lead part 82′ and the fourth lead part 92′) on their facing sides, so that an amount of heat that can be relieved outside through the lead parts is limited. This may cause a problem with heat concentration (an increase in temperature) in the facing portion between the first coil 80′ and the second coil 90′.

On the other hand, according to the present embodiment, since the first coil 80 and the second coil 90 include four lead parts (the first lead part 81, the second lead part 82, the third lead part 91, and the fourth lead part 92) on their facing sides, it is possible to efficiently relieve heat outside through these lead parts. This makes it possible to reduce heat concentration (an increase in temperature) in the facing portion between the first coil 80 and the second coil 90.

Note that, in the examples illustrated in FIGS. 2, 3 and so on, the first lead part 81, the second lead part 82, the third lead part 91, and the fourth lead part 92 are all placed on the facing sides, but only any three of them may be placed on the facing sides. Further, the first lead part 81, the second lead part 82, the third lead part 91, and the fourth lead part 92 are all formed on both sides in the Y-direction, but may be formed on any positions in the Y-direction.

Further, in the examples illustrated in FIGS. 2, 3 and so on, the intersecting part 94 extends in a diagonal direction with respect to the X-direction in a state where the intersecting part 94 forms part of the winding part 93, but may extend in parallel to the X-direction. In this case, the intersecting part 94 extends in parallel to the predetermined axis I.

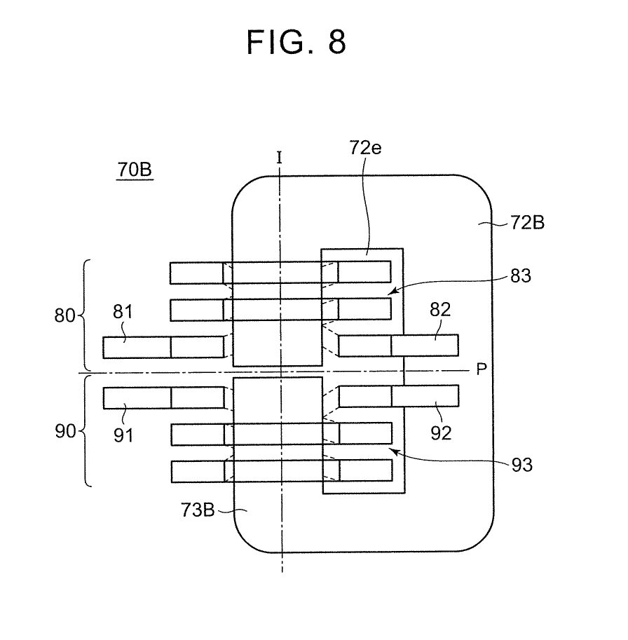

FIG. 8 is a top view diagrammatically illustrating a reactor device 70B according to another embodiment (Embodiment 2).

Embodiment 2 is different from Embodiment 1 mainly in that a magnetic core 72B has a U-shape. The other configurations of Embodiment 2 may be substantially the same as those in Embodiment 2, so that the same reference signs are attached thereto and description of the other configurations are omitted.

The magnetic core 72B may be formed by placing two U-shaped cores so as to face each other, or may be formed integrally in a ring shape. Further, the magnetic core 72B may be formed of a single U-shaped core.

Similarly to the above, a first coil 80 and a second coil 90 are placed coaxially around a predetermined axis. In the example illustrated in FIG. 8, the first coil 80 and the second coil 90 are wound around a one-side central leg 73B of the magnetic core 72B so as to pass through a central slot 72e. In this case, the leg 73B defines a predetermined axis I. The first coil 80 and the second coil 90 may be wound around the predetermined axis I in a similar manner to the abovementioned Embodiment 1.

Even Embodiment 2 yields the effect similar to that of Embodiment 1 described above. That is, since the first coil 80 and the second coil 90 include four lead parts (the first lead part 81, the second lead part 82, the third lead part 91, and the fourth lead part 92) on their facing sides, it is possible to efficiently relieve heat outside through these lead parts. This makes it possible to reduce heat concentration (an increase in temperature) in the facing portion between the first coil 80 and the second coil 90.

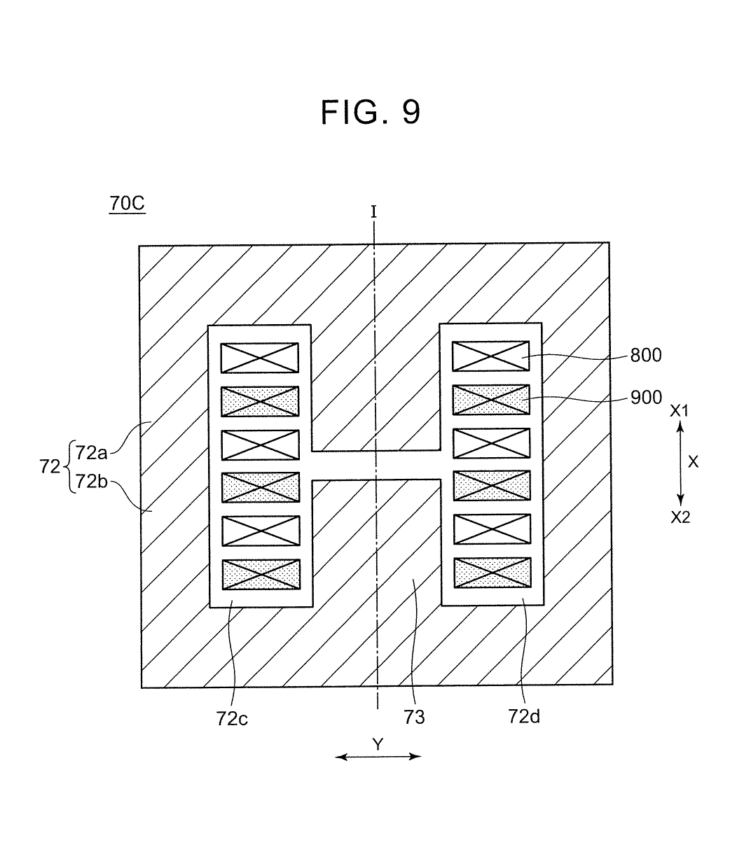

FIG. 9 is a sectional view illustrating a reactor device 70C in another embodiment (Embodiment 3).

The reactor device 70C includes a magnetic core 72, a first coil 800, and a second coil 900. The magnetic core 72 may be configured in a similar manner to Embodiment 1.

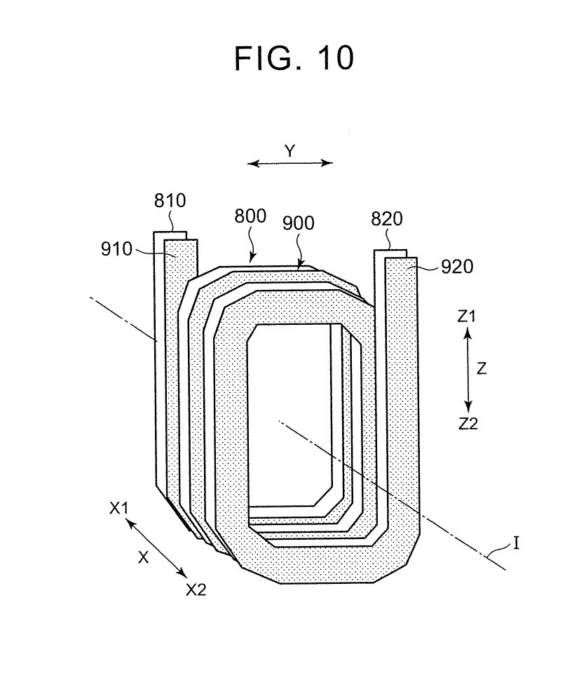

The first coil 800 and the second coil 900 are placed coaxially around a predetermined axis. In the example illustrated in FIG. 9, the first coil 800 and the second coil 900 are wound around a central leg 73 of the magnetic core 72 so as to pass through two slots 72c, 72d of the magnetic core 72. In this case, the central leg 73 defines a predetermined axis I (see FIGS. 9, 10). The first coil 800 and the second coil 900 are typically made of the same material. Each of the first coil 800 and the second coil 900 is preferably formed of that square wire having a rectangular section which can handle a larger current as compared with a thin circular wire having a circular section. However, each of the first coil 800 and the second coil 900 may be formed of a thin circular wire having a circular section.

FIG. 10 is a view schematically illustrating the first coil 800 and the second coil 900 in the reactor device 70C. FIG. 10 is a perspective view schematically illustrating only the first coil 800 and the second coil 900 taken out of the reactor device 70C illustrated in FIG. 9.

The first coil 800 and the second coil 900 are wound in a single layer around the predetermined axis. At this time, the first coil 800 and the second coil 900 are wound alternately in a direction of the predetermined axis (X-direction) as illustrated in FIG. 10.

The first coil 800 includes a first lead part 810 on an X1 side in the X-direction, and a second lead part 820 on an X2 side in the X-direction. The first lead part 810 and the second lead part 820 serve as terminals, and are connected to other components (elements of an electric circuit). For example, in a case where the first coil 800 constitutes the primary-side first reactor 204a, the first lead part 810 and the second lead part 820 may be connected to the middle point 207m of the primary-side first arm circuit 207 and one end of the primary-side first winding 202a, respectively.

The second coil 900 includes a third lead part 910 on the X1 side in the X-direction, and a fourth lead part 920 on the X2 side in the X-direction. The third lead part 910 and the fourth lead part 920 serve as terminals, and are connected to other components (elements of an electric circuit). For example, in a case where the second coil 900 constitutes the primary-side second reactor 204b, the third lead part 910 and the fourth lead part 920 may be connected to the middle point 211m of the primary-side second arm circuit 211 and one end of the primary-side second winding 202b, respectively.

Note that, in this example, the first coil 800 and the second coil 900 are wound in the same number of windings, but they may be wound in different numbers of windings. Further, the first lead part 810 and the second lead part 820 are drawn toward a Z1 side in a Z-direction in this example. However, a direction where the first lead part 810 and the second lead part 820 are drawn is optional. For example, the first lead part 810 may be drawn toward the Z1 side in the Z-direction, and the second lead part 820 may be drawn toward a Z2 side in the Z-direction. Similarly, the third lead part 910 and the fourth lead part 920 are drawn toward the Z1 side in the Z-direction. However, the third lead part 910 may be drawn toward the Z1 side in the Z-direction, and the fourth lead part 920 may be drawn toward the Z2 side in the Z-direction, for example.

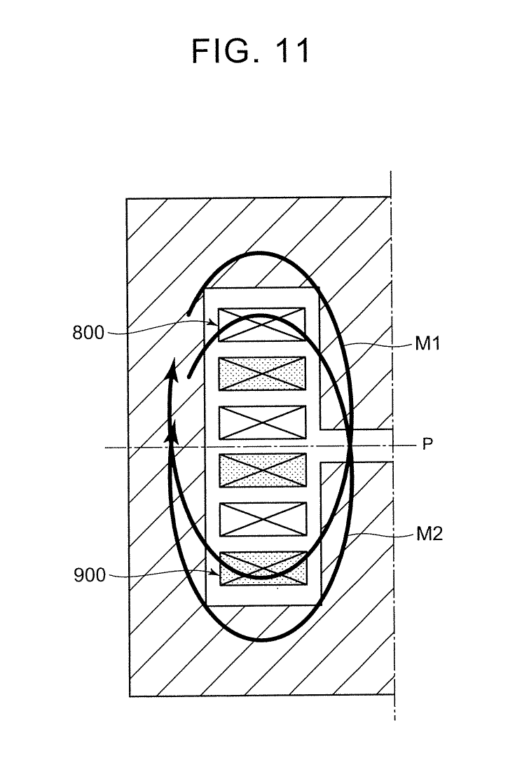

FIG. 11 is a view schematically illustrating a state of magnetic fluxes caused in the reactor device 70C, and a view corresponding to FIG. 7 in Embodiment 1 described above.

In Embodiment 3, the first coil 800 and the second coil 900 are wound alternately around the predetermined axis I, as described above. When a current is applied to the first coil 800 and the second coil 900, respective magnetic fluxes M1, M2 are formed as diagrammatically illustrated in FIG. 11. However, concentration of the magnetic fluxes M1, M2 is suppressed (see FIG. 7 as a comparison). That is, in Embodiment 3, the concentration of the magnetic fluxes M1, M2 is suppressed at the time of current application of the first coil 800 and the second coil 900, thereby reducing an amount of heat generation. Further, heat generation parts are dispersed, thereby making it possible to perform cooling easily. Note that according to CAE (computer-aided engineering) analysis by the inventor(s) of the present invention, it is found that a coil heat generation amount in Embodiment 3 is reduced to about ¼ of a coil heat generation amount in the comparative example illustrated in FIGS. 6A, 6B.

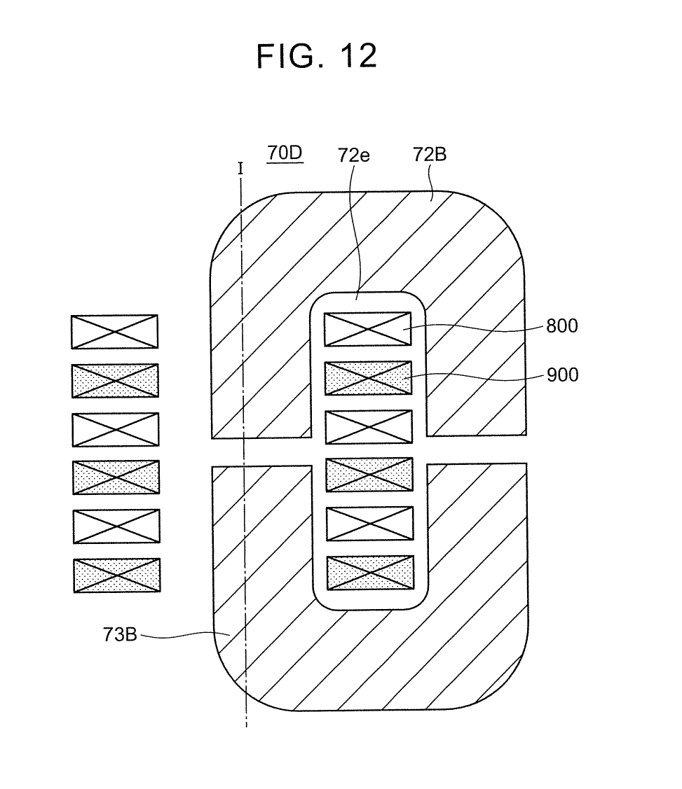

FIG. 12 is a sectional view diagrammatically illustrating a reactor device 70D according to another embodiment (Embodiment 4). Embodiment 4 is different from Embodiment 3 mainly in that a magnetic core 72B has a U-shape. The other configurations of Embodiment 4 may be substantially the same as those in Embodiment 3, so that the same reference signs are attached thereto and description of the other configurations are omitted. A magnetic core 72B may be configured in a similar manner to Embodiment 2.

The magnetic core 72B may be formed by placing two U-shaped cores so as to face each other, or may be formed integrally in a ring shape. Further, the magnetic core 72B may be formed of a single U-shaped core.

Similarly to the above, a first coil 800 and a second coil 900 are placed coaxially around a predetermined axis. In the example illustrated in FIG. 12, the first coil 800 and the second coil 900 are wound around a one-side central leg 73B of the magnetic core 72B so as to pass through a central slot 72e. In this case, the leg 73B defines a predetermined axis I. The first coil 800 and the second coil 900 may be wound around the predetermined axis I in a similar manner to the abovementioned Embodiment 3.

Even Embodiment 4 yields the effect similar to that of Embodiment 3 described above. That is, concentration of magnetic fluxes is suppressed at the time of current application to the first coil 800 and the second coil 900, thereby making it possible to reduce a whole amount of heat generation of the first coil 800 and the second coil 900.

Each embodiment has been described above, but this invention is not limited to any specific embodiment, and various modifications and alternations can be made within a scope of Claims. Further, all or some of constituents in the above embodiment can be combined.

For example, the reactor devices 70A, 70B in the above embodiments are not limited to a magnetic coupling reactor in the power conversion device 10 having a configuration as illustrated herein, but also usable as a magnetic coupling reactor in a power conversion device having a different configuration. Further, the reactor devices 70A, 70B in the embodiments can be used as a transformer.

Further, in Embodiment 3 and Embodiment 4, the first coil 800 and the second coil 900 are wound in a single layer, but may be configured by a multi-layer winding in which the first coil 800 wand the second coil 900 are wound alternately in each layer.

What is claimed is:

1. A reactor comprising:
a magnetic core that defines a predetermined axis;
a first coil that is wound around the predetermined axis; and
a second coil that is wound around the predetermined axis and is placed opposed to the first coil, wherein:
a first lead part and a second lead part formed in both ends of the first coil are placed on that side of the first coil which is opposed to the second coil.

2. The reactor according to claim 1, wherein:
the first coil includes the first lead part, a single-layer winding part that is wound in a single layer around the predetermined axis, the second lead part, and an intersecting part that passes on an inner side or an outer side of the single-layer winding part so as to intersect with the single-layer winding part.

3. The reactor according to claim 1, wherein:
a third lead part and a fourth lead part formed in both ends of the second coil are placed on that side of the second coil which is opposed to the first coil.

4. The reactor according to claim 3, wherein:
the second coil includes the third lead part, a single-layer winding part that is wound in a single layer around the predetermined axis, the fourth lead part, and an intersecting part that passes on an inner side or an outer side of the single-layer winding part so as to intersect with the single-layer winding part.

5. The reactor according to claim 1, wherein:
the first coil and the second coil are each formed of a square wire having a rectangular section.

6. A reactor comprising:
a magnetic core that defines a predetermined axis;
a first coil that is wound around the predetermined axis; and
a second coil that is wound around the predetermined axis alternately with the first coil in a direction of the predetermined axis.

7. The reactor according to claim 6, wherein:
the first coil and the second coil are each wound in a single layer around the predetermined axis.

8. The reactor according to claim 6, wherein:
the first coil and the second coil are each formed of a square wire having a rectangular section.

9. A power conversion device comprising:
a primary side circuit provided with a first reactor including a first magnetic core that defines a first predetermined axis, a first coil that is wound around the first predetermined axis, and a second coil that is wound around the first predetermined axis and is placed opposed to the first coil, the first coil includes a first lead part and a second lead part that are formed in both ends of the first coil, the first lead part and the second lead part are placed on that side of the first coil which is opposed to the second coil; and
a secondary side circuit that is magnetically coupled with the primary side circuit via a transformer and is provided with a second reactor that includes a second magnetic core defining a second predetermined axis, a third coil that is wound around the second predetermined axis, and a fourth coil that is wound around the second predetermined axis and is placed opposed to the third coil, the third coil includes a third lead part and a fourth lead part that are formed in both ends of the third coil, the third lead part and the fourth lead part are placed on that side of the third coil which is opposed to the fourth coil.

10. A power conversion device comprising:
a primary side circuit provided with a first reactor including a first magnetic core that defines a first predetermined axis, a first coil that is wound around the first predetermined axis, and a second coil that is wound around the first predetermined axis alternately with the first coil in a direction of the predetermined axis; and
a secondary side circuit that is magnetically coupled with the primary side circuit via a transformer and is provided with a second reactor that includes a second magnetic core that defines a second predetermined axis, a third coil that is wound around the second predetermined axis, and a fourth coil that is wound around the second predetermined axis alternately with the third coil in a direction of the second predetermined axis.
